(19) United States
(12) Patent Application Publication
(10) Pub. No.: US 2025/0061049 A1
(43) Pub. Date: Feb. 20, 2025

(54) DETERMINING RELEVANT TESTS THROUGH CONTINUOUS PRODUCTION-STATE ANALYSIS

(71) Applicant: Cisco Technology, Inc., San Jose, CA (US)

(72) Inventors: Sebastian Jeuk, München (DE); Gonzalo A Salgueiro, Raleigh, NC (US); M. David Hanes, Lewisville, NC (US); Matthew R. Engle, Plano, TX (US)

(21) Appl. No.: 18/449,120

(22) Filed: Aug. 14, 2023

(51) Int. Cl. G06F 11/36

(52) U.S. Cl. CPC G06F 11/3688; G06F 11/3696

(57) ABSTRACT

A system and method are provided that use an intelligence model that continuously learns and identifies changes within a production computing environment and determines if adjustments/changes to be made in the production computing environment are to be validated during testing based on a set of criteria. The intelligence model determines possible adjustments in a computing environment (and their impact during testing) that have been learned from stored/accumulated data associated with a plurality of production computing environments over time.

### TECHNICAL FIELD

The present disclosure relates to testing of production deployed data centers and networks.

### BACKGROUND

Testing is a key aspect to reduce risk of production deployments. However, being able to test as close to the production environment (and its state) is still a challenge, especially when looking at complete network architectures. Tests replicated in lab environments usually miss at least 10 to 15% of a production environment's similarity by simply replicating the architecture without the actual production data. Production environments are a living entity that continuously change, may that be through administrative changes (i.e. adding or removing APICs in an APIC cluster) through continuous use with production grade traffic or other environmental aspects that influence the state of the living entity.

### BRIEF DESCRIPTION OF THE DRAWINGS

FIG. 1 is a high-level diagram of a system according to an example embodiment.

FIG. 2 is a operational flow diagram of the system depicted in FIG. 1, according to an example embodiment.

FIG. 3 is a diagram depicting example uses of the system depicted in FIG. 1, according to an example embodiment.

FIG. 4 is a flow chart for a method according to an example embodiment.

FIG. 5 is a hardware block diagram of a computing device that may perform functions associated with any combination of operations in connection with the techniques depicted and described in connection with FIGS. 1-4, according to various example embodiments.

### DESCRIPTION OF EXAMPLE EMBODIMENTS

### Overview

In one form, a computer-implemented method is provided. The computer-implemented method includes obtaining configuration information describing a configuration of a production computing environment. The production computing environment including one or more computing devices and associated software, one or more networking devices and associated software and one or more data storage devices and associated software. The computer-implemented method includes obtaining testing information relating to a particular testing scenario to be performed for the production computing environment. The computer-implemented method includes monitoring operation of the production computing environment to obtain a history of operational states and a plurality of changes made to the production computing environment over time. The computer-implemented method includes obtaining operational and testing data collected over time for a plurality of other production computing environments that have undergone a plurality of testing scenarios and configuration changes that impact the plurality of testing scenarios. The computer-implemented method further includes determining one or more particular changes of the plurality of changes to the production computing environment that should be validated for the particular testing scenario.

### Example Embodiments

Testing of software running in a computing environment can reduce risk of deploying a new design or code version within a production computing environment. Determining the relevant test cases specific to a particular computing environment is useful to provide the most specific outcome possible. While test engineers can use their experience, it is impossible to determine all relevant test cases reflecting changes over time made in a production computing environment. The techniques presented herein solve an important technical problem and achieve a practical application of obtaining more accurate and relevant testing of software in a computing environment.

A system and method are provided that use a testing configuration intelligence model that continuously learns and identifies changes within a production computing environment and determines if adjustments/changes to be made in the production computing environment are to be validated during testing (based on a set of criteria). The intelligence model determines possible adjustments in a computing environment (and their impact during testing) that have been learned from stored/accumulated data (“adjustment database”) associated with a plurality of production computing environments over time. This adjustment database provides a starting point for the intelligence model to determine whether an adjustment in a production computing environment is worthwhile.

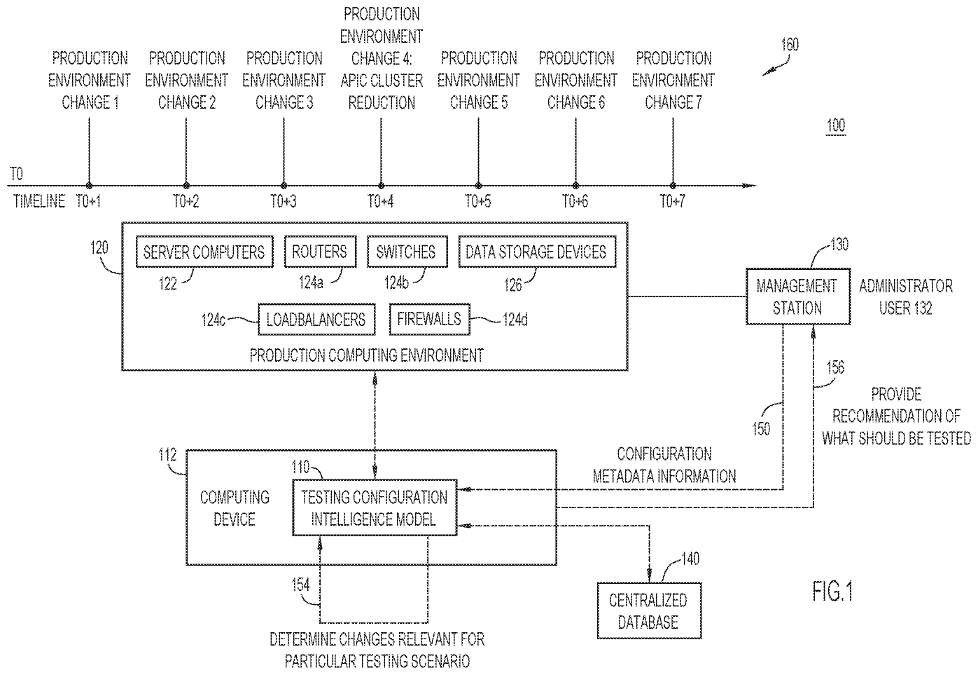

Reference is now made to FIG. 1. FIG. 1 illustrates a high-level diagram of a system 100 according to an example embodiment. The system 100 includes a testing configuration intelligence model 110 (that may run on one or more computing devices 112 in the cloud) that are in communication with a production computing environment 120. The production computing environment 120 may include one or more server computers 122, networking equipment such as routers 124a, switches 124b, loadbalancers 124c, and firewalls 124d, as well as data storage devices 126, and any other computing, networking, data storage or other devices and software now known or hereinafter developed that may be used in a datacenter or computing environment, such as those used in enterprise computing environments. Other terms that may be used to refer to the production computing environment 120 include a deployed computing environment, an actual in-use computing environment or system, a deployed datacenter, a deployed computing system, a deployed enterprise network, etc. All of these terms are meant to indicate that the production computing environment 120 is deployed and in use/operation.

There may be a management station/console 130 that an administrator user 132 interacts with in order to oversee operation of the production computing environment 120. The console/management station 130 is in communication with the testing configuration intelligence model 110. In addition, the testing configuration intelligence model 110 may be in communication with a centralized database 140 (the aforementioned “adjustment database”) that stores information about configuration changes in other computing environments. The management station/console 130 may be a standard computing device, e.g., desktop or laptop computer, which runs one or more network or computing system management software applications that can monitor and configure operations of the production computing environment 120.

The testing configuration intelligence model 110 obtains as input several items of data/information. First, as shown at 150, the administrator user 132, via the console/management station 130, provides metadata information about the current set up of the production computing environment 120. The administrator user 132 may specify metadata information that includes configuration and/or design aspects, as well as one or more reasons for testing the production computing environment 120, such as code certification, feature validation, etc.

The centralized database 140 stores a history of all faults, alerts and events associated with the production computing environment 120, as well as a plurality of other production computing environments that contain equipment and software provided by one or more vendors. The data stored by the centralized database 140 may be anonymized, as desired or needed.

At 152, the testing configuration intelligence model 110 continuously monitors the production computing environment 120 for changes made to it over time. The testing configuration intelligence model 110 learns the changes, the impact in configuration states and uses this information to determine which changes (based on the metadata information obtained from the administrator user 132) are relevant for a testing scenario specific to the production computing environment 120.

At 154, the testing configuration intelligence model 110 uses the metadata information obtained by the administrator user 132 as well as the data obtained from the centralized database 140 to autonomously determine which changes in the production computing environment 120 are relevant for a particular testing scenario specific to the production computing environment 120 and the tests to be executed. As an example, in the timeline 160, there are numerous changes made to the production computing environment 120. The testing configuration intelligence model 110 determines that Change 4 (Application Policy Infrastructure Controller (APIC) Cluster Reduction) is important for a planned software upgrade. Thus, the testing configuration intelligence model 110 determines Change 4 is to be replicated/verified as part of the lab/test environment validation of the planned software upgrade. The testing configuration intelligence model 110 determines that other changes that happen over time in the production computing environment 120 are not determined to be important for this particular test scenario, and therefore are indicated as such to the administrator user 132.

At 156, the testing configuration intelligence model 110 provides to the administrator user 132 a recommendation of what should be tested based on the received input from the administrator user 132 and the continuously monitoring of the production computing environment 120. Again, the testing configuration intelligence model 110 uses the data stored in the centralized database 140 to enrich other data to be analyzed with information from other production computing environments.

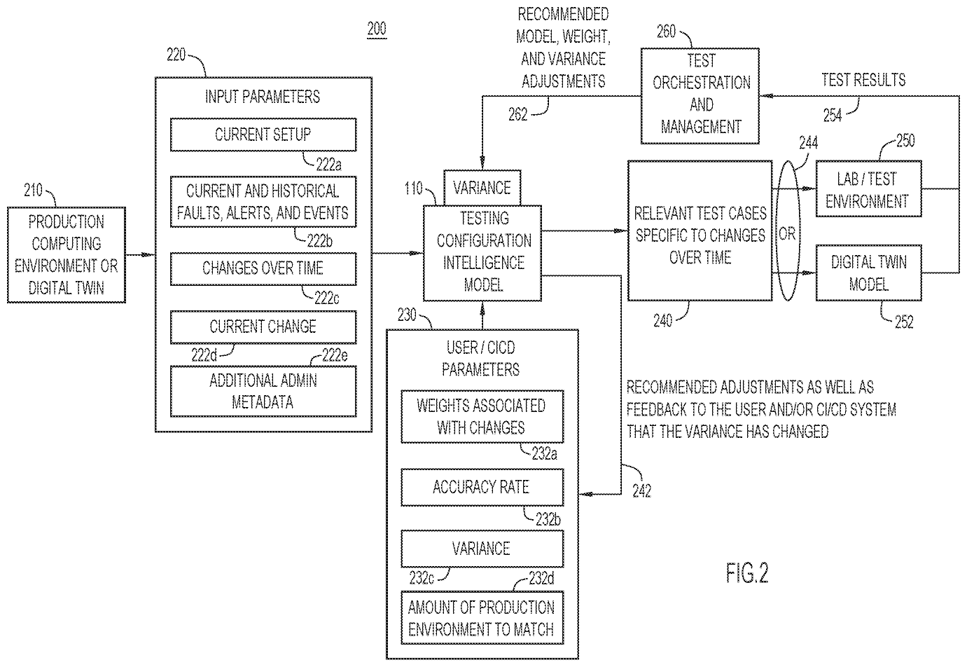

Reference is now made to FIG. 2. FIG. 2 illustrates a flow diagram 200 depicting, in more detail, operation of a testing configuration intelligence model 110 for a production computing environment or digital twin model of the production computing environment 210. Input parameters 220 are provided to the testing configuration intelligence model 110. The input parameters 220 may include information describing the current setup 222a of the production computing environment 210, current and historical faults, alerts and events shown at 222b, changes 222c made over time to the production computing environment 210, one or more current changes 222d to the production computing environment 210 and additional administrator (admin) metadata 222e. The additional admin metadata 222e could be any information related to the production computing environment 210, including the test scenario (i.e. code certification vs feature validation). The input parameters 220 could be from either/both the production computing environment and/or a digital twin of the production computing environment. Determining what input parameters to choose to provide the most accurate outcome for a specific environment can be done either by the testing configuration intelligence model 110 autonomously (i.e. learning over time which input parameters resulted in the most accurate output parameters by evaluating the provided feedback) or by an administrator user through metadata details.

An administrator user may manually or automatically provide a second set of input data that helps describe the changes made, the level of variance when considering changes for testing, and any other metadata the user/automation system deems necessary/relevant. For example, an administrator user or a continuation integration/continuous delivery (CI/CD) service may provide user/CICD parameters 230 to the testing configuration intelligence model 110. The user/CICD parameters 230 may include weights associated with changes 232a (either automatically assigned or assigned by the administrator user). For example, an administrator user can define a weight to the identified changes that happened within a production environment over time to indicate if a change has more potential impact than another change. The testing configuration intelligence model 110 also may be involved in automatically assigning weights based on historical changes that are similar based on learning from other setups/scenarios. The user/CICD parameters 230 may further include an accuracy rate 232b to be employed by the testing configuration intelligence model 110, a variance 232c when considering changes for testing, and an amount/portion 232d of the production computing environment 210 to match when applying changes for testing.

Based on the input parameters 220 and the user/CICD parameters 230, at 240, the testing configuration intelligence model 110 determines relevant test cases specific to changes of the production computing environment 210 over time. As explained above, the testing configuration intelligence model 110 may use machine learning (ML)/artificial intelligence (AI) to determine the relevant test cases. The testing configuration intelligence model 110 may take into account metadata associated with the input parameters 220 and user/CICD parameters 230, such as an ordered list of changes to the production computing environment 210 over a time frame, relevant database states, and other over-time adjustments.

At 242, the testing configuration intelligence model 110 may output recommended adjustments to the administrator user and/or CI/CD system as a result of the analysis it performs. Examples of such recommended adjustments may include metadata specific to the test cases identified, such as setup details that are used to execute the test cases in order to hit/trigger the identified issue; an indication of whether the variance level is too restrictive or not restrictive enough for the desired level of testing; a potential impact to the CI/CD pipeline; and adjustments to the user entered parameters to reflect thresholds used by similar changes (e.g., set your parameter to >=X in order to net meaningful results). Moreover, the testing configuration intelligence model 110 may provide feedback to the user and/or CI/CD system with regard to the variance, such as: the current variance is too restrictive/not restrictive enough to determine relevant test cases; executed test cases all fail, indicating that more coverage should be provided; and the production environment undersent a major change (e.g., design change) and hence a variance should be adjusted to adapt to that change. Again, the variance may be viewed as a deviation range of one or more parameters for one or more particular changes to the production computing environment. The variance can be appropriate, or it can be too restrictive or not restrictive enough, for a given parameter.

At 244, the testing configuration intelligence model 110 may output relevant test cases to a lab/test computing environment 250 and/or digital twin model 252 of the production computing environment 210. The test results 254 produced by the lab/test computing environment 250 and/or digital twin model 252 may be supplied to a test orchestration and management function 260. Based on the test results, the test orchestration and management function 260 generates recommended model, weight and variance adjustments 262 that are provided back to the testing configuration intelligence model 110. The test orchestration and management function 260 may correlate current production/digital twin state and historical changes/events/faults with a known error database. This can be performed in multiple ways, one of which involves use of machine learning (ML) techniques. Ultimately, the testing configuration intelligence model 110 outputs a set of test cases specific to the production computing environment 210 that can then be executed in the production computing environment 210 prior, during or after an update or configuration change in the production computing environment 210.

The techniques presented herein involve several aspects not heretofore known. First, these techniques rely on specific input data that, when correlated by the testing configuration intelligence model 110, helps to determine what production changes are important to replicate in a test environment to assure production-like testing and relevant test results. Second, the output describes the changes to be made in a test computing environment in order to accurately reflect the production computing environment. As shown at 242 and 262 in FIG. 2, a feedback loop is provided to inform an administrator user and the testing configuration intelligence model 110 to dynamically make adjustments accordingly. Third, the techniques involve determining, based on the input parameters 220, test cases that are relevant to assure the introduced changes are appropriately covered and weighted.

The testing configuration intelligence model 110 may be used to learn over time the correlation between changes made in the production computing environment, issues found and how these changes and issues are correlated. The insight the testing configuration intelligence model 110 obtains by this process allows it to autonomously determine which production changes should be tested for a specific testing scenario. The data that the testing configuration intelligence model 110 uses may come from a variety of different sources (technical assistance center queries, service reports, testing done by a centralized system, user data collected by dashboards, etc.) to build an extensive data set with which the testing configuration intelligence model 110 can generate decisions. These processes are ongoing and hence improve further over time.

The aforementioned variance parameter is now further explained. To be able to influence the accuracy and/or granularity of the testing configuration intelligence model 110 in determining what should be tested and what does not need testing, a variance parameter can be provided by the administrator user. The testing configuration intelligence model 110 uses the variance parameter to include occurrences of production changes that would not otherwise be considered relevant. For example, the testing configuration intelligence model 110 determines that production changes A, D and J are relevant for an upgrade scenario performed on a software program from version 3.2 to version 5.2 of the software program. With the variance parameter set, the testing configuration intelligence model 110 can be configured to be more lenient in determining what changes in the production computing environment 210 are relevant for testing. For example, setting the variance parameter to a medium value (this can be determined based on the implementation) the testing configuration intelligence model 110 would also include production changes C, S, R, T, and U, whereas setting the variance parameter to a higher or stronger value would limit/restrict the changes to be considered relevant for a particular testing scenario. During running of the testing scenario in the test computing environment, it may be determined that the upgrade failed. For example, this may due to a code change in version 5.2 that handles stale entries (like that created by the APIC cluster downsizing) and causes the fabric to be unstable. This issue would have caused a rollback in production environment. With the techniques presented herein, the intelligence model provides a test engineer with the necessary details to perform relevant tests and assure functionality specific to the production computing environment and its state.

Conventional procedures validate configuration changes right before deploying them in production. Such an approach is used in day-to-day operations but is not feasible in validating a new software version, a design change, or any other major change to production. In these cases, the as-is production configuration (as of a certain time) is used and installed in a replica test environment. By doing so, state changes that occur over time are lost and not considered. CI/CD based automated state changes are considered declarative. They define what changes and automation is used to make the change in production.

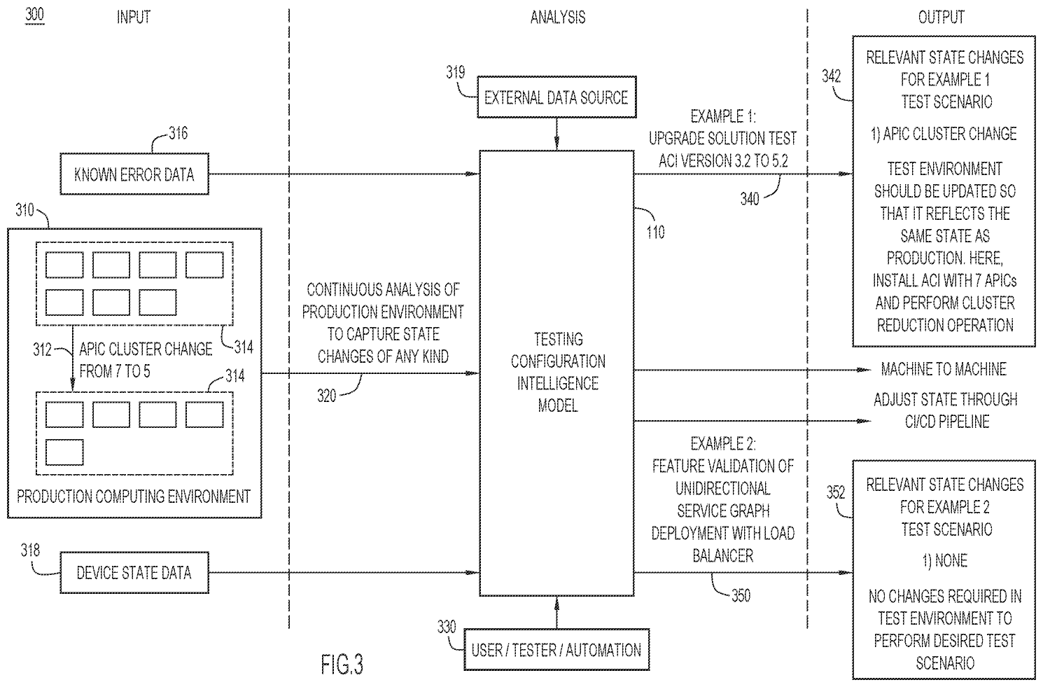

Reference is now made to FIG. 3 for description of still another example of the techniques presented herein. FIG. 3 shows a diagram of a system 300 that includes a production computing environment 310 and the testing configuration intelligence model 110. In this example, the production computing environment 310 undergoes a state change 312 in which an APIC cluster 314 changes from 7 APICs to 5 APICs. Associated with the production computing environment 310 the testing configuration intelligence model 110 receives as input, known error data 316 from a central database of errors maintained over time as well as device state data 318 associated with the devices in the production computing environment 310. The device state data 318 may include logs, warnings, faults, errors, etc. The testing configuration intelligence model 110 may also receive input from an external data source 319 such as a test case database or change management system, code repository of source of network traffic flow data. As shown at 320, the testing configuration intelligence model 110 also performs continuous analysis of the production computing environment 310 to capture state changes that may occur. In particular, the testing configuration intelligence model 110 performs continuous analysis to determine state changes that are relevant for a specific test scenario.

As shown at 330, information describing a test scenario and any associated metadata (such as the variance parameter) is provided to the testing configuration intelligence model 110. This information may be received from an administrator user, test system or automatically generated input. The testing configuration intelligence model 110 determines relevant changes to the production computing environment 310 based on a large data set learned over time that allows application of artificial intelligence/machine learning to correlate state changes to a desired/intended test scenario.

FIG. 3 shows two specific examples. A first example test, shown at 340, is an upgrade solution test from one ACI version to another ACI version (e.g., from version 3.2 to version 5.2). Using software code version validation as an example, solution testing is to validate the overall functionality of the solution, and not merely a single configuration change. That is, the desire is to validate the upgrade procedure, convergence through negative testing and performance testing and all under the relevant circumstances. Upgrade testing, without having first defined the right APIC cluster state change (i.e. removing 2 APICs from a 7 APIC cluster), will lead a different result than simply defining a new 5 APIC cluster state. As shown at 342, the testing configuration intelligence model 110 determines that the relevant state changes to be made in the test computing environment (or digital twin) is the APIC cluster change (from 7 to 2). The test computing environment is then updated so that it reflects the same state as the production computing environment 310, and in this example, this involves installing ACI with 7 APICs and then performing a cluster reduction operation to 5 APICs.

A second example, shown at 350, is a feature validation of unidirectional service graph deployment with a load balancer. As shown at 352, the testing configuration intelligence model 110 determines that there are no relevant state changes for this type of test. In other words, no changes are to be made in the test environment to perform this test scenario.

It should be appreciated that the techniques presented herein can make use of the state changes performed through a CI/CD pipeline by using these as an input parameter to determine what has happened to a production environment, comparing it to the data set and outlining relevant states for a particular testing scenario.

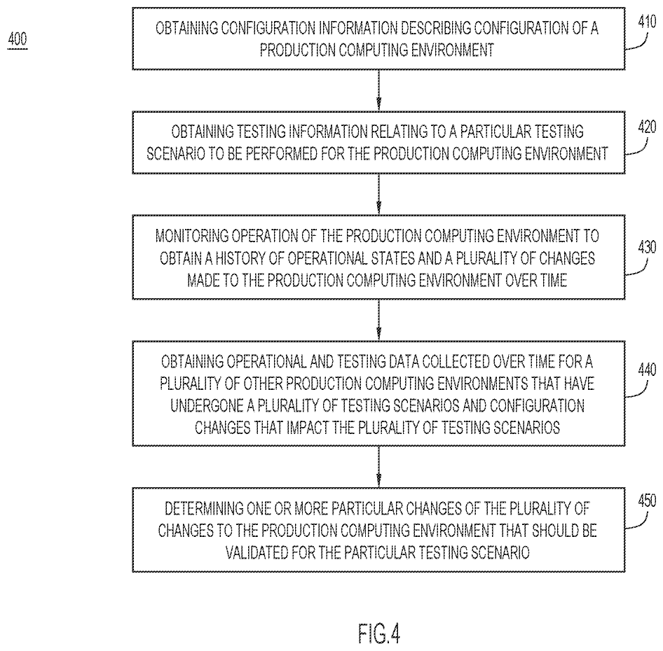

Reference is now made to FIG. 4, which illustrates a flow chart depicting a method 400 according to an example embodiment. Reference is also made to FIGS. 1-3 for purposes of the description of FIG. 4. The method 400 is a computer-implemented method that generates as output a list of one or more one or more particular changes of the plurality of changes to the production computing environment that should be validated for the particular testing scenario. At step 410, the method 400 includes obtaining configuration information describing a configuration of a production computing environment. The production computing environment may include one or more computing devices and associated software, one or more networking devices and associated software and one or more data storage devices and associated software.

At step 420, the method includes obtaining testing information relating to a particular testing scenario to be performed for the production computing environment. This particular testing scenario may be determined by an administrator user or by the aforementioned testing configuration intelligence model 110.

At step 430, the method 400 includes monitoring operation of the production computing environment to obtain a history of operational states and a plurality of changes made to the production computing environment over time.

At step 440, the method 400 includes obtaining operational and testing data collected over time for a plurality of other production computing environments that have undergone a plurality of testing scenarios and configuration changes that impact the plurality of testing scenarios.

At step 450, the method 400 includes determining one or more particular changes of the plurality of changes to the production computing environment that should be validated for the particular testing scenario.

In summary, a process and related techniques are provided that involve the use of a intelligence model that autonomously determines, based on input data received/collected, if a historical change in the production environment is critical for a test scenario or not. An administrator user may specify metadata that can include information about the test scenario, weight details for specific changes and other relevant information related to testing and the production environment. The intelligence model integrates with one or more centralized databases to collect bulk data from a plurality (e.g., hundreds) of other production environments as well as test related information on changes that impacted specific test scenarios.

The intelligence model continuously monitors the production computing environment, changes made as well as events/warnings and faults raised over time. It thereby learns all relevant state information of the production computing environment that will be used as the basis to determine what state changes (i.e. a configuration change) is relevant for the specified test scenario. The intelligence model determines which changes, if any, have a high risk of causing an issue during production activities (e.g., an upgrade) and hence should be subject to pre-validation in testing. The outcome of the autonomous determination may be translated into a recommendation that is provided to the administrator user to act on and plan the testing accordingly.

As described above, the intelligence model may take the form of a heuristic, ML/AI or otherwise intelligent/learning-based system, based on all the input parameters received. The intelligence model outputs a list of relevant test cases that are highly specific to the changes made over time, the known errors those changes can potentially cause, and any relevant metadata provided by the user/an automation system. Each test case may be defined with a set of test case metadata details that outline the context of why the test case is relevant and why it was chosen.

The state of a production computing environment is an ongoing and fluent process. Configuration changes are done regularly and continuously. While configuration changes, for example, can be validated as part of the pipeline execution, solution testing is often done for a specific “event”. The techniques presented herein allow for testing both aspects, and as a result will have a greater impact when executing solution tests. The intelligence model learns over time the correlation between changes made in production, issues found and how these correlate. The insight gained by this process is used by the to determine autonomously which production changes should be tested for a specific testing scenario.

In one embodiment, the intelligence model may create a test-to-production equivalence model. The equivalence model is influenced by a set of input parameters including (1) output of the intelligence model, (2) intended equivalence level (i.e. 95% vs 100%) and (3) constraints. An equivalence model to test a specific feature in a broader architecture will look different to an equivalence model to verify the overall architecture. The equivalence model describes the production computing environment and its current and historical state to achieve the desired test-to-production equivalence.

The techniques presented herein may be useful to help with the reproduction and troubleshooting of issues in a deployed enterprise network. A technical assistance center often has to reproduce complex issues quickly to help in problem isolation and resolution as well as upgrade assistance and assessment for large customers. Employing these techniques in a technical assistance center could provide greater efficiencies in these scenarios. Solution validation services could also benefit as these techniques allow a better match to the deployed network and in order to mimic real changes and better predict problems.

Again, the techniques presented herein involve a set of input parameters that helps determine highly specific and relevant test cases for historical changes, an intelligence system that can leverage a proposed set of input parameters to determine the test cases, and output of the test cases with a set of metadata that describes the test cases relevancy to the production computing environment.

This invention proposes an Intelligence Model that continuously learns and identifies changes within the production environment and determines if adjustments in production are to be validated during testing (based on a set of criteria). The Intelligence Model then determines the impact characteristics of a change. The impact defines if a change (either current or over time) has the potential to influence test results. The proposed Intelligence Model highlights all relevant changes that happened in the production environment over time to the administrator.

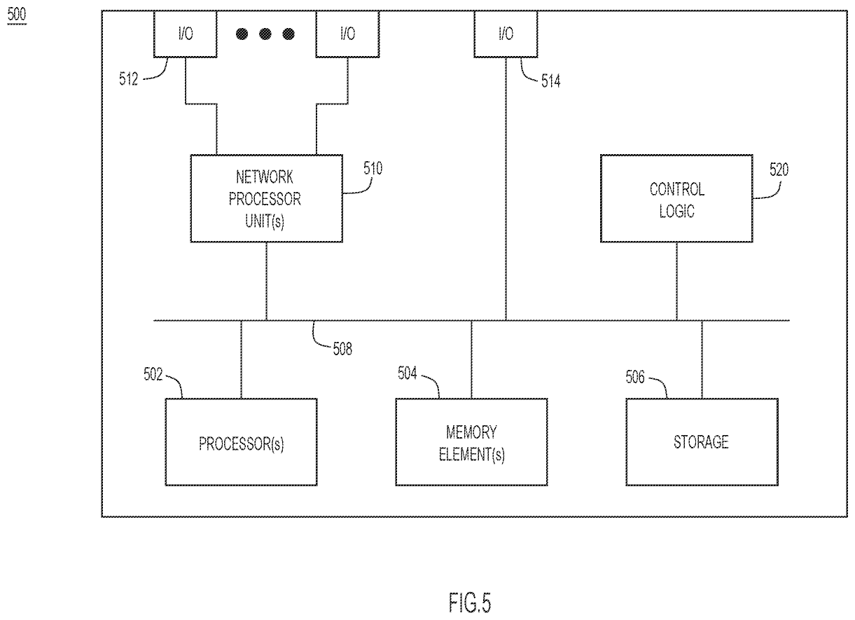

FIG. 5 is a hardware block diagram of a device (e.g., a computing device, networking device or multiple instances of such computing devices) that may perform functions associated with any combination of operations in connection with the techniques depicted in FIGS. 1-4, according to various example embodiments. It should be appreciated that FIG. 5 provides only an illustration of one example embodiment and does not imply any limitations with regard to the environments in which different example embodiments may be implemented. Many modifications to the depicted environment may be made.

In at least one embodiment, the computing device 500 may be any apparatus that may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a computer-implemented method including: obtaining configuration information describing a configuration of a production computing environment, the production computing environment including one or more computing devices and associated software, one or more networking devices and associated software and one or more data storage devices and associated software; obtaining testing information relating to a particular testing scenario to be performed for the production computing environment; monitoring operation of the production computing environment to obtain a history of operational states and a plurality of changes made to the production computing environment over time; obtaining operational and testing data collected over time for a plurality of other production computing environments that have undergone a plurality of testing scenarios and configuration changes that impact the plurality of testing scenarios; and determining one or more particular changes of the plurality of changes to the production computing environment that should be validated for the particular testing scenario.

In some aspects, the techniques described herein relate to a computer-implemented method, wherein determining the one or more particular changes includes performing machine learning analysis of the operational and testing data and on the history of the operational states of the production computing environment and the plurality of changes made to the production computing environment over time.

In some aspects, the techniques described herein relate to a computer-implemented method, further including: assigning a respective weight to one or more of the plurality of changes made to the production computing environment, wherein the respective weight represents a relative impact of an associated change among the plurality of changes.

In some aspects, the techniques described herein relate to a computer-implemented method, wherein assigning is performed in response to input from an administrative user or is automatically performed based on a software process based on the operational and testing data.

In some aspects, the techniques described herein relate to a computer-implemented method, wherein determining further includes determining one or more test cases for the particular testing scenario that are specific to the one or more particular changes and known errors the one or more particular changes can potentially cause in the production computing environment.

In some aspects, the techniques described herein relate to a computer-implemented method, determining further includes defining metadata details that outline a context as to why each of the one or more test cases is relevant.

In some aspects, the techniques described herein relate to a computer-implemented method, wherein determining the one or more particular changes further includes determining a variance representing a deviation range of one or more parameters for the one or more particular changes.

In some aspects, the techniques described herein relate to a computer-implemented method, further including executing the particular testing scenario in a test computing environment or a digital twin model of the production computing environment with the one or more particular changes in place to replicate the production computing environment.

In some aspects, the techniques described herein relate to a computer-implemented method, wherein executing the particular testing scenario produces test results, and further including generating adjustments to the variance based on the variance.

In some aspects, the techniques described herein relate to a computer-implemented method, wherein executing further includes executing the particular testing scenario in the production computing environment.

In some aspects, the techniques described herein relate to a computer-implemented method, wherein the one or more particular changes include an ordered list of changes for purposes of executing the particular testing scenario.

In some aspects, the techniques described herein relate to a computer-implemented method, wherein determining is performed based further on one or more state changes performed through a continuation integration/continuous delivery (CI/CD) pipeline.

In some aspects, the techniques described herein relate to an apparatus including: a communication interface that enables communication with a production computing environment, the production computing environment including one or more computing devices and associated software, one or more networking devices and associated software and one or more data storage devices and associated software; memory; one or more computer processors configured to execute instructions stored in the memory to perform operations including: obtaining configuration information describing a configuration of a production computing environment; obtaining testing information relating to a particular testing scenario to be performed for the production computing environment; monitoring operation of the production computing environment to obtain a history of operational states and a plurality of changes made to the production computing environment over time; obtaining operational and testing data collected over time for a plurality of other production computing environments that have undergone a plurality of testing scenarios and configuration changes that impact the plurality of testing scenarios; and determining one or more particular changes of the plurality of changes to the production computing environment that should be validated for the particular testing scenario.

In some aspects, the techniques described herein relate to an apparatus, wherein the one or more computer processors perform the determining the one or more particular changes by performing machine learning analysis of the operational and testing data and on the history of the operational states of the production computing environment and the plurality of changes made to the production computing environment over time.

In some aspects, the techniques described herein relate to an apparatus, wherein the one or more computer processors are further configured to perform an operation of: assigning a respective weight to one or more of the plurality of changes made to the production computing environment, wherein the respective weight represents a relative impact of an associated change among the plurality of changes.

In some aspects, the techniques described herein relate to an apparatus, wherein the one or more computer processors are further configured to perform an operation of: determining the one or more particular changes further includes determining a variance representing a deviation range of one or more parameters for the one or more particular changes; and executing the particular testing scenario in a test computing environment or a digital twin model of the production computing environment with the one or more particular changes in place to replicate the production computing environment.

In some aspects, the techniques described herein relate to one or more non-transitory computer readable storage media encoded with instructions that, when executed by one or more computer processors, cause the one or more computer processors to perform operations including: obtaining configuration information describing a configuration of a production computing environment, the production computing environment including one or more computing devices and associated software, one or more networking devices and associated software and one or more data storage devices and associated software; obtaining testing information relating to a particular testing scenario to be performed for the production computing environment; monitoring operation of the production computing environment to obtain a history of operational states and a plurality of changes made to the production computing environment over time; obtaining operational and testing data collected over time for a plurality of other production computing environments that have undergone a plurality of testing scenarios and configuration changes that impact the plurality of testing scenarios; and determining one or more particular changes of the plurality of changes to the production computing environment that should be validated for the particular testing scenario.

In some aspects, the techniques described herein relate to one or more non-transitory computer readable storage media, wherein determining the one or more particular changes includes performing machine learning analysis of the operational and testing data and on the history of the operational states of the production computing environment and the plurality of changes made to the production computing environment over time.

In some aspects, the techniques described herein relate to one or more non-transitory computer readable storage media, wherein determining the one or more particular changes further includes determining a variance representing a deviation range of one or more parameters for the one or more particular changes, and further including instructions that, when executed by the one or more computer processors, cause the one or more computer processors to perform an operation including: executing the particular testing scenario in a test computing environment or a digital twin model of the production computing environment with the one or more particular changes in place to replicate the production computing environment.

In some aspects, the techniques described herein relate to one or more non-transitory computer readable storage media, wherein executing the particular testing scenario produces test results, and further including instructions that cause the one or more computer processors to perform an operation including generating adjustments to the variance based on the variance.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts. As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining configuration information describing a configuration of a production computing environment, the production computing environment including one or more computing devices and associated software, one or more networking devices and associated software and one or more data storage devices and associated software;
obtaining testing information relating to a particular testing scenario to be performed for the production computing environment;
monitoring operation of the production computing environment to obtain a history of operational states and a plurality of changes made to the production computing environment over time;
obtaining operational and testing data collected over time for a plurality of other production computing environments that have undergone a plurality of testing scenarios and configuration changes that impact the plurality of testing scenarios; and
determining one or more particular changes of the plurality of changes to the production computing environment that should be validated for the particular testing scenario.

2. The computer-implemented method of claim 1, wherein determining the one or more particular changes comprises performing machine learning analysis of the operational and testing data and on the history of the operational states of the production computing environment and the plurality of changes made to the production computing environment over time.

3. The computer-implemented method of claim 1, further comprising:
assigning a respective weight to one or more of the plurality of changes made to the production computing environment, wherein the respective weight represents a relative impact of an associated change among the plurality of changes.

4. The computer-implemented method of claim 3, wherein assigning is performed in response to input from an administrative user or is automatically performed based on a software process based on the operational and testing data.

5. The computer-implemented method of claim 1, wherein determining further comprises determining one or more test cases for the particular testing scenario that are specific to the one or more particular changes and known errors the one or more particular changes can potentially cause in the production computing environment.

6. The computer-implemented method of claim 5, determining further includes defining metadata details that outline a context as to why each of the one or more test cases is relevant.

7. The computer-implemented method of claim 1, wherein determining the one or more particular changes further includes determining a variance representing a deviation range of one or more parameters for the one or more particular changes.

8. The computer-implemented method of claim 7, further comprising executing the particular testing scenario in a test computing environment or a digital twin model of the production computing environment with the one or more particular changes in place to replicate the production computing environment.

9. The computer-implemented method of claim 8, wherein executing the particular testing scenario produces test results, and further comprising generating adjustments to the variance based on the variance.

10. The computer-implemented method of claim 8, wherein executing further comprises executing the particular testing scenario in the production computing environment.

11. The computer-implemented method of claim 1, wherein the one or more particular changes comprise an ordered list of changes for executing the particular testing scenario.

12. The computer-implemented method of claim 1, wherein determining is performed based further on one or more state changes performed through a continuation integration/continuous delivery (CI/CD) pipeline.

13. An apparatus comprising:
a communication interface that enables communication with a production computing environment, the production computing environment including one or more computing devices and associated software, one or more networking devices and associated software and one or more data storage devices and associated software;
memory;
one or more computer processors configured to execute instructions stored in the memory to perform operations including:
obtaining configuration information describing a configuration of a production computing environment;
obtaining testing information relating to a particular testing scenario to be performed for the production computing environment;
monitoring operation of the production computing environment to obtain a history of operational states and a plurality of changes made to the production computing environment over time;
obtaining operational and testing data collected over time for a plurality of other production computing environments that have undergone a plurality of testing scenarios and configuration changes that impact the plurality of testing scenarios; and
determining one or more particular changes of the plurality of changes to the production computing environment that should be validated for the particular testing scenario.

14. The apparatus of claim 13, wherein the one or more computer processors perform the determining the one or more particular changes by performing machine learning analysis of the operational and testing data and on the history of the operational states of the production computing environment and the plurality of changes made to the production computing environment over time.

15. The apparatus of claim 13, wherein the one or more computer processors are further configured to perform an operation of:
assigning a respective weight to one or more of the plurality of changes made to the production computing environment, wherein the respective weight represents a relative impact of an associated change among the plurality of changes.

16. The apparatus of claim 13, wherein the one or more computer processors are further configured to perform an operation of:
determining the one or more particular changes further includes determining a variance representing a deviation range of one or more parameters for the one or more particular changes; and
executing the particular testing scenario in a test computing environment or a digital twin model of the production computing environment with the one or more particular changes in place to replicate the production computing environment.

17. One or more non-transitory computer readable storage media encoded with instructions that, when executed by one or more computer processors, cause the one or more computer processors to perform operations including:
obtaining configuration information describing a configuration of a production computing environment, the production computing environment including one or more computing devices and associated software, one or more networking devices and associated software and one or more data storage devices and associated software;
obtaining testing information relating to a particular testing scenario to be performed for the production computing environment;
monitoring operation of the production computing environment to obtain a history of operational states and a plurality of changes made to the production computing environment over time;
obtaining operational and testing data collected over time for a plurality of other production computing environments that have undergone a plurality of testing scenarios and configuration changes that impact the plurality of testing scenarios; and
determining one or more particular changes of the plurality of changes to the production computing environment that should be validated for the particular testing scenario.

18. The one or more non-transitory computer readable storage media of claim 17, wherein determining the one or more particular changes comprises performing machine learning analysis of the operational and testing data and on the history of the operational states of the production computing environment and the plurality of changes made to the production computing environment over time.

19. The one or more non-transitory computer readable storage media of claim 17, wherein determining the one or more particular changes further includes determining a variance representing a deviation range of one or more parameters for the one or more particular changes, and further comprising instructions that, when executed by the one or more computer processors, cause the one or more computer processors to perform an operation including:
executing the particular testing scenario in a test computing environment or a digital twin model of the production computing environment with the one or more particular changes in place to replicate the production computing environment.

20. The one or more non-transitory computer readable storage media of claim 19, wherein executing the particular testing scenario produces test results, and further comprising instructions that cause the one or more computer processors to perform an operation including generating adjustments to the variance based on the variance.
